(19) United States
(12) Patent Application Publication
(10) Pub. No.: US 2004/0020516 A1
(43) Pub. Date: Feb. 5, 2004

(54) Gutter debris vacuum

(76) Inventor: Don Martin Buckner, Okahumpka, FL (US)

Correspondence Address: Don M. Buckner, 3702 Rodgers Industrial Park, Okahumpka, FL, 34762, US

(21) Appl. No.: 10/212,022

(22) Filed: Aug. 5, 2002

(51) Int. Cl. B08B 5/04

(52) U.S. Cl. 134/21; 134/22.12

(57) ABSTRACT

A method for removing debris from a roof gutter includes the steps of providing a vacuum conduit having a first end located in proximity to the debris in the gutter and a second end connected to a vacuum tank, having a vacuum producing means, the first end of the vacuum conduit having water and/or air dispensing means to dislodge or make vacuum able the debris located within the gutter. The debris is vacuumed into the vacuum tank by means of the vacuum conduit. Mechanical means may also be utilized in proximity of the first end of the vacuum conduit to break up debris. A monitoring means may be utilized in proximity to the first end of the vacuum conduit to monitor vacuuming progress and/or control vacuum and/or debris dislodging means.

### BACKGROUND OF THE INVENTION

1. Field of the Invention

The present invention relates to the field of cleaning debris from roof gutters. More particularly, the present invention relates to the field of vacuuming debris from a roof gutter.

2. Background of the Invention

Roof gutters mounted at the edge of building roofs to catch and remove rainwater, also catch fragments of roofing, tree leaves, twigs, flowers, seeds, and airborne debris. The general debris restricts the intended flow of rainwater in the gutters, thus the debris need be removed.

The most prevalent method of cleaning a gutter is to have a person climb up to the gutter and remove the debris by hand. A mechanical device such as a scraper is often employed to dislodge tangled debris.

Mechanical devices such as “shepherd's hook” style poles and extension poles have been used in order to allow a person to mechanically scrape the debris from a roof gutter. Blowers with “shepherd's hook” style conduits have been used to blow loose debris out on the gutter and on to every thing in the general area. Tangled debris is difficult, if not impossible, to remove with this method.

Canister type vacuum cleaners such as “shop vacuums” and “domestic vacuums” have been used to vacuum loose debris from gutters, but they do not have sufficient vacuum or air velocity or cubic feet per minute of airflow to adequately remove leaves, twigs and tangled debris.

Agitator heads with auger screw and beater paddles have been added to the suction hose end of inadequate canister type vacuum cleaners to help overcome their insufficient vacuum, insufficient air velocity and insufficient airflow in cubic feet per minute.

A “shepherd's hook” tubular attachment to a portable air blower in U.S. Pat. No. 4,402,106 issued Sep. 6, 1983 to Charles A. Mattson may remove loose debris from a gutter but the loose debris is blown onto the roof where it may redeposit itself in the gutter or it is blown over the yard and operator.

A “shepherd's hook” suction pipe attached to a canister type vacuum cleaner in U.S. Pat. No. 5,195,209 issued to Richard Watkins Mar. 23, 1993, will vacuum loose debris from a roof rain gutter while allowing the operator to remain on the ground but the canister type vacuum does not produce sufficient vacuum, air velocity, or move sufficient cubic feet of air to dislodge and make vacuum able the debris such as twigs, leaves, and seeds which tangle together.

The inadequate vacuum, inadequate air velocity, and inadequate cubic feet per minute of air flow produced by a canister type vacuum cleaner is attempted to be overcome by adding a mechanical agitator head with mechanical screw in U.S. Pat. No. 6,185,782 B1.

It is therefore and objective of the present invention to provide suction hose in proximity to the debris within a roof gutter having a vacuum, air velocity, and cubic feet per minute air flow exceeding that of a domestic canister vacuum cleaner.

It is yet another objective of the present invention to provide a suction hose in proximity to the debris within a rain gutter having a vacuum, air velocity, and air volume sufficient to remove loose debris and dislodge tangled debris.

It is yet another objective of the present invention to provide a suction hose in proximity to the debris within a rain gutter having a commercial or industrial vacuum producing means attached.

It is yet another objective of the present invention to provide a suction hose in proximity to the debris within a rain gutter having a water spray nozzle attached in proximity to the suction end of the suction hose to further clean the gutter.

It is yet another objective of the present invention to provide a suction hose in proximity to the debris within a rain gutter having over 4 inches of mercury vacuum, over 150 cubic feet of airflow at velocities over 500 feet per minute.

It is yet another objective of the present invention to provide a suction hose in proximity to the debris within a rain gutter having a water spray nozzle providing over 100 pounds per square inch of water pressure and being in proximity to the suction end of the suction hose to further clean the gutter.

It is yet another objective of the present invention to allow the operator to remain on the ground while operating the vacuum hose system.

It is yet another objective of the present invention to provide a monitor in proximity of the suction end of the vacuum hose in order to control system functions and/or relay information to the operator.

It is yet another objective of the present invention to provide compressed air in proximity to the suction end of the suction hose in order to further clean and/or dry the gutter.

Other features and advantages of the present invention will become apparent from the following detailed drawings and description, which illustrate by example, the principles of the invention.

### BRIEF DESCRIPTION OF THE DRAWINGS

The accompanying drawings illustrate the present invention and are a part of the specifications. Together with the following description, the drawings demonstrate and explain the principles of the present invention.

FIG. 1—Illustrates a vacuum conduit vacuuming debris from a gutter into a holding tank having a vacuum within it.

FIG. 2—Illustrates a vacuum conduit vacuuming debris from a gutter into a vacuum tank with the addition of a water pump providing water to a spray head near the suction end of the suction hose.

FIG. 3—Illustrates a vacuum conduit with a flow through vacuum means located between the gutter debris end and the holding tank end of the vacuum conduit. An air compressor provides compressed air to the gutter and a mechanical dislodger is shown.

FIG. 4—Illustrates a gutter vacuum conduit with a monitor located in proximity to the suction and of the vacuum conduit, a water spray means, a compressed air means and a mechanical dislodger are shown.

FIG. 5—Illustrates a cut away view of the gutter with a vacuum conduit cleaning the gutter with the assistance of a water spray, air nozzle and mechanical dislodger.

### DETAILED DESCRIPTION OF THE PREFERRED EMBODIMENT

Using the drawings, the preferred embodiment of the present invention will now be explained.

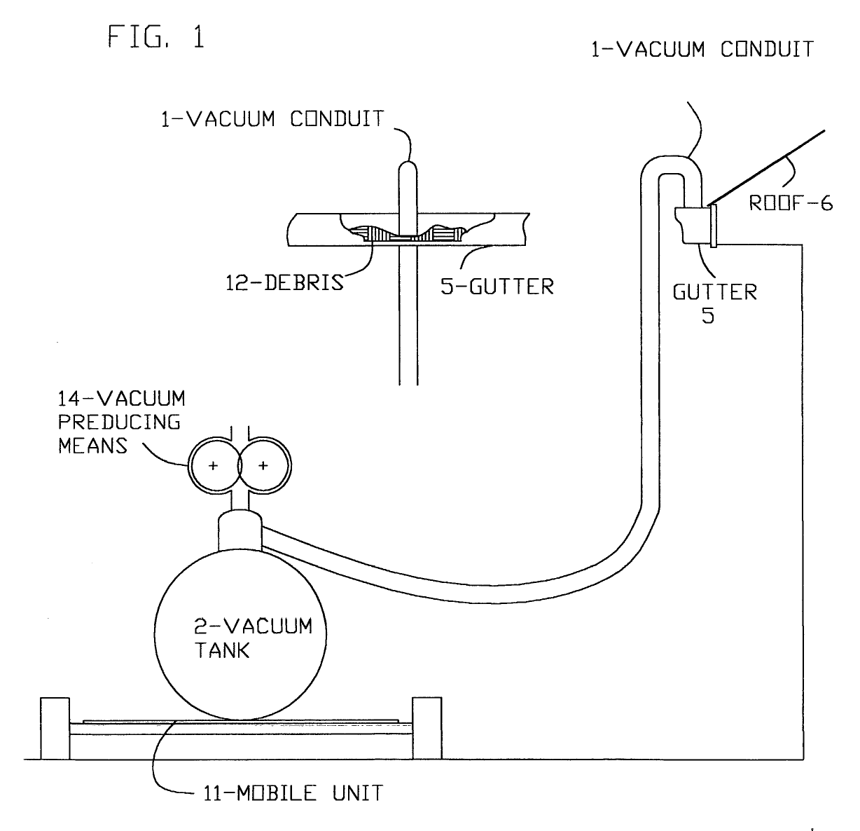

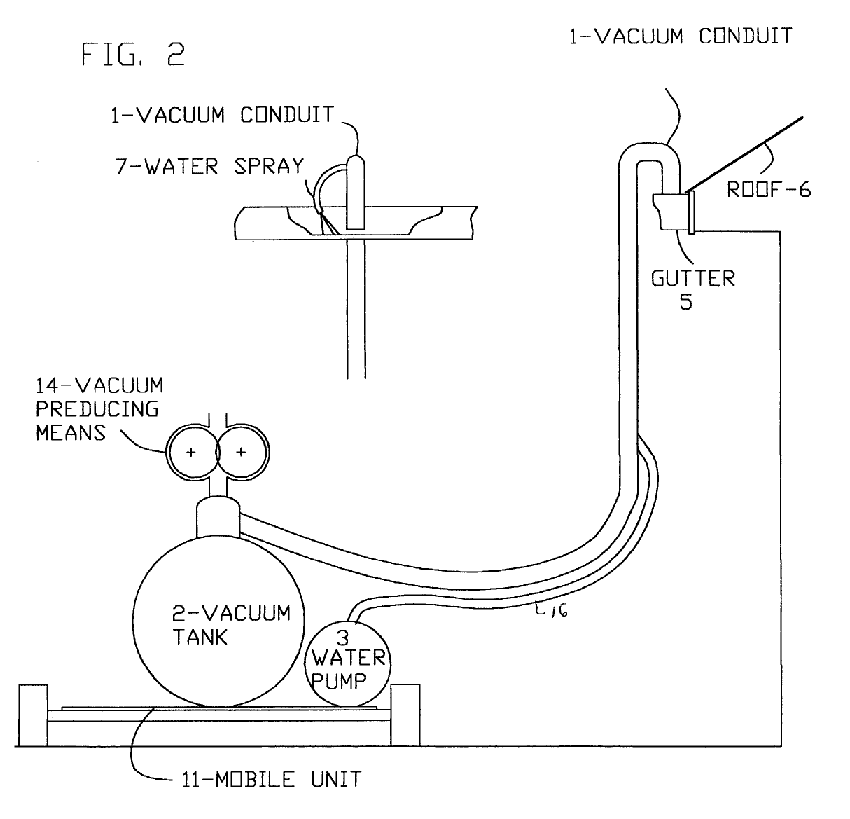

FIGS. 1, 2, 3 and 4 show a first end of a vacuum conduit 1 in proximity to gutter 5 debris 12. The gutter 5 is located at the edge of a roof 6. In FIGS. 1, 2 and 3, a vacuum container 2 is attached to a second end of vacuum conduit 1. The vacuum container 2 has a vacuum producing means 14 in FIGS. 1 and 2. Vacuum producing means 14 produces over 4 inches of mercury vacuum and in excess of 150 CFM of air. The vacuum container 2 serves as a surge tank for the vacuum and a holding tank for the vacuumed debris 12.

The vacuum container 2 is mounted on a mobile means 11. The mobile unit 11 maybe a trailer or a powered mobile means.

FIG. 1 represents a gutter 5 debris 12 vacuum means with a vacuum producing means 14 capable of producing a vacuum in excess of 4 inches of mercury and a volume of air movement in excess of 150 cubic feet per minute. The first end of the vacuum conduit 1 is placed in proximity to the debris 12. The second end of the vacuum conduit 1 is attached to the vacuum container 2. Sufficient vacuum force and air movement are generated at the first end of vacuum conduit 1 to dislodge and vacuum debris 12 from the gutter 5 into the vacuum holding container 2.

In a second embodiment of the invention shown in FIG. 2, the addition of a water pressure means 3 supplies water to a water spray means 7 located in proximity to the first end of vacuum conduit 1. Liquid under pressure is moved from water pressure means 3 to water spray means 7 by conduit 16.

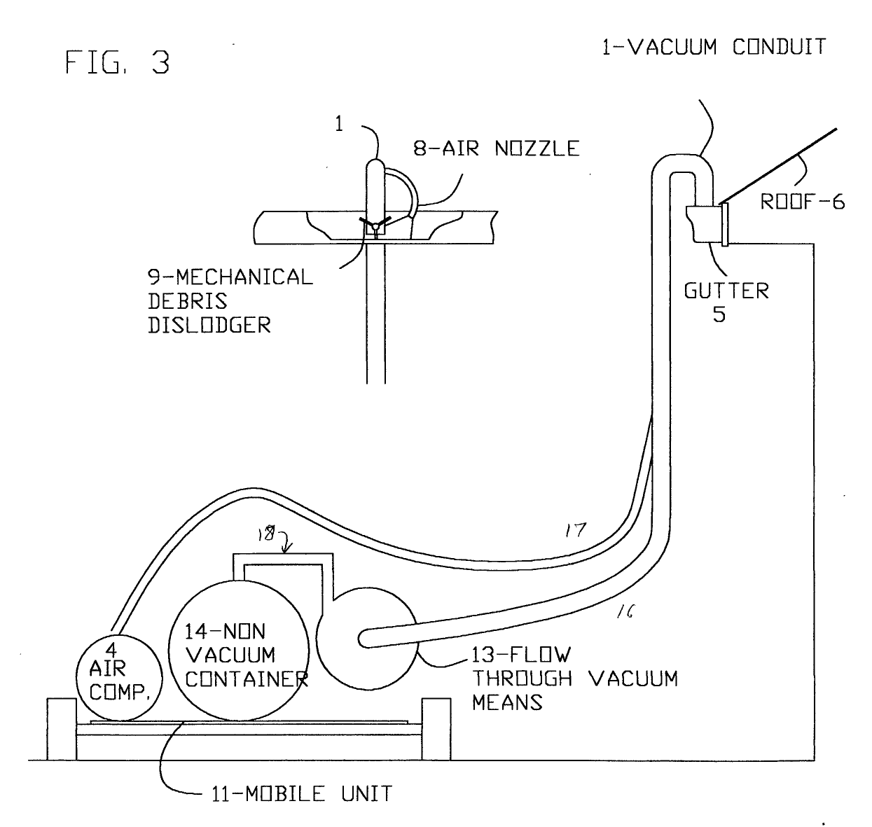

In a third embodiment of the invention shown in FIG. 3, the second end of vacuum conduit 1 is attached to the intake of a flow through vacuum means 13. The discharge of the flow through vacuum means 13 is attached to a first end of conduit 18 and the second end of conduit 18 is attached to a non-vacuum debris storage container 14, thus debris 12 vacuumed from gutter 5 flows through vacuum conduit 1 then through vacuum means 13, then through conduit 18 and then into container 14. An air pressure producing device 4 supplies air under pressure through conduit 17 to air distribution nozzle 8 which is located in proximity to the first end of vacuum conduit 1. A mechanical means 9 is located in proximity to the first end of conduit 1 in order to assist in cleaning debris from the gutter.

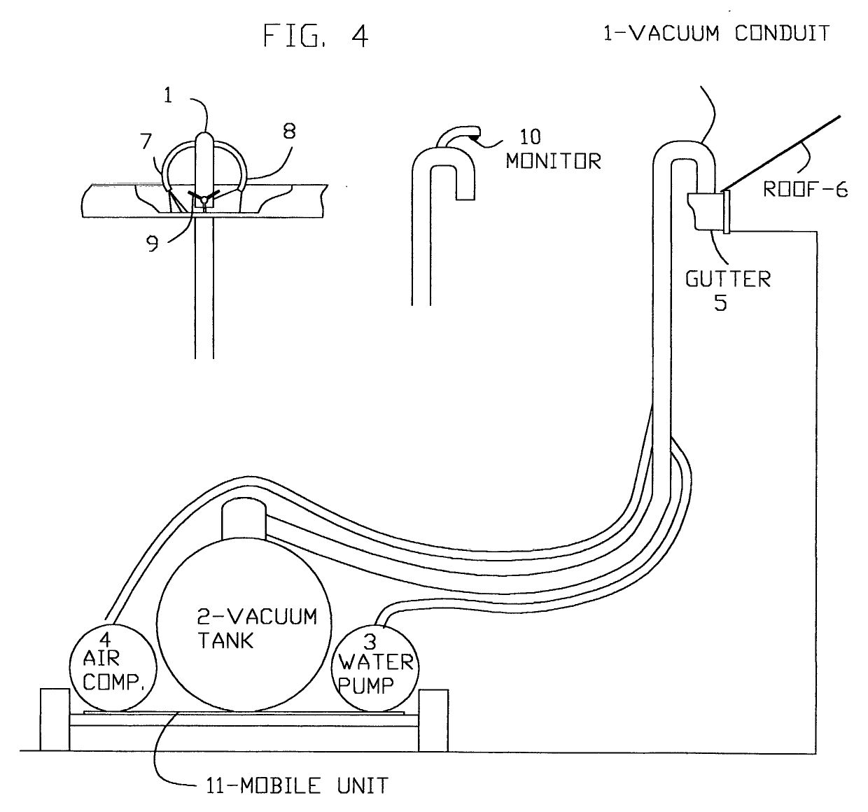

In a fourth embodiment of the invention shown in FIG. 4, a monitor 10 is added in order to gather data and transmit that data to the operator and to a operations control means.

The fourth embodiment is an example of the present invention incorporating the combined features of a mechanical means 9, a water spray means 7 and an air distribution means 8 in order to thoroughly clean debris 12 from gutter 5.

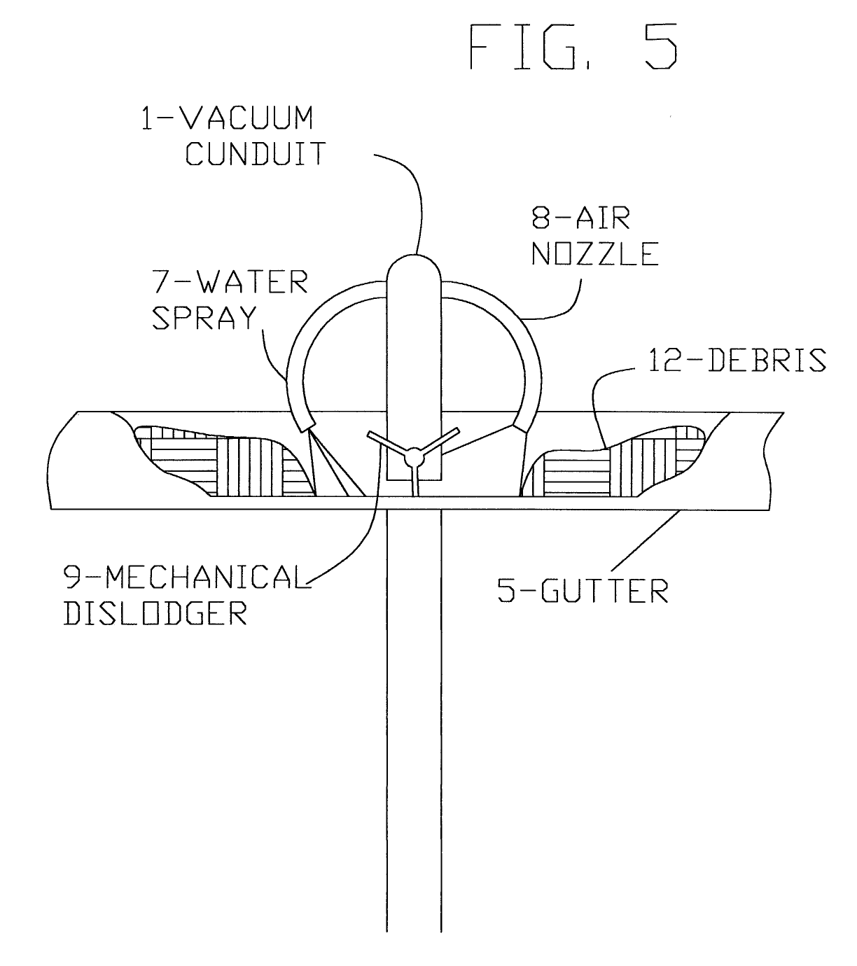

FIG. 5 is an enlarged view of the fourth embodiment of the invention showing a cross section of gutter 5 being cleaned of debris 5.

What is claimed:

1. A method for vacuuming debris from a rain gutter which comprises the steps of:
Providing a vacuum conduit having a first end located in proximity to the debris in a rain gutter and a second end connected to a vacuum producing means, having the ability to vacuum debris from the gutter by means of said vacuum conduit.

2. The method in claim 1 further comprising the steps of:
Providing a vacuum producing means capable of producing in excess of 4 inches of mercury vacuum and vacuum in excess of 150 cubic feet of air per minute.

3. The method in claim 1 or 2 comprising a vacuum conduit and vacuum producing means sufficient to dislodge and vacuum debris from a rain gutter.

4. The method in claim 1, 2 or 3 wherein the vacuum conduit has means of reaching the gutter debris without the operator climbing up to the gutter.

5. The method in claim 1, 2, 3 or 4 wherein a liquid spray nozzle is placed in proximity to the first end of the vacuum conduit, said liquid spray nozzle having liquid supplied to it by a conduit attached to the spray nozzle at the first end and attached to a liquid pressure producing means at the second end.

6. The method in claim 1, 2, 3, 4 or 5 wherein a vacuum container means is attached to the second end of the vacuum conduit.

7. The method in claim 1, 2, 3, 4, 5 or 6 wherein the debris is passed through the vacuum producing means.

8. The method in claim 1, 2, 3, 4, 5, 6 or 7 wherein the vacuumed debris is vacuumed into the vacuum container means.

9. The method in claim 7 wherein the debris is vacuumed through the vacuum producing means into a non-vacuum container.

10. The method in claim 1, 2, 3, 4, 5, 6, 7, 8 or 9 wherein a compressed air dispensing nozzle is placed in proximity to the first end of the vacuum conduit, said compressed air dispensing nozzle having compressed air supplied to it by a conduit attached to said air nozzle at the first end and attached to a compressed air producing means at the second end.

11. The method in claim 1, 2, 3, 4, 5, 6, 7, 8, 9 or 10 wherein a monitor means is placed in proximity to the first end of the vacuum conduit, said monitor having the means to control the debris vacuuming process or provide information to the operator.

12. The method in claim 1, 2, 3, 4, 5, 6, 7, 8, 9, 10 or 11 wherein the debris vacuum means are mounted on a mobile means.

13. The method in claim 1, 2, 3, 4, 5, 6, 7, 8, 9, 10 or 11 wherein the debris vacuum means arc mounted on a powered mobile means.

14. The method in claims 1 through 14 wherein a mechanical debris dislodging means is placed in proximity to the first end of the vacuum conduit.
